(19) United States
(12) Patent Application Publication
(10) Pub. No.: US 2013/0173912 A1
(43) Pub. Date: Jul. 4, 2013

(54) DIGITAL RIGHT MANAGEMENT METHOD, APPARATUS, AND SYSTEM

(71) Applicants: Peking University Founder Group Co., Ltd., Beijing (CN); Beijing Founder Apabi Technology Ltd., Beijing (CN); Peking University, Beijing (CN); Founder Information Industry Holdings Co., Ltd., Beijing (CN)

(72) Inventors: Xiaoyu CUI, Beijing (CN); Zhi Tang, Beijing (CN)

(73) Assignees: Peking University Founder Group Co., Ltd., Beijing (CN); Founder Information Industry Holdings Co., Ltd., Beijing (CN); Peking University, Beijing (CN); Beijing Founder Apabi Technology Ltd., Beijing (CN)

(21) Appl. No.: 13/730,148

(22) Filed: Dec. 28, 2012

(30) Foreign Application Priority Data
Dec. 28, 2011 (CN) 201110448508.4

(51) Int. Cl. H04L 9/32

(52) U.S. Cl. CPC H04L 9/3294
USPC 713/156; 713/175

(57) ABSTRACT

A digital right management method, including: generating, by a first user equipment having access right to shared digital contents, a common public key based on one or more public keys of one or more second user equipments intended to share the digital contents, respectively; encrypting, by the first user equipment, a key of the digital contents with the common public key to generate a ciphertext of the key of the digital contents; generating, by the first user equipment, from the ciphertext a new authorization certificate corresponding to the digital contents; and transmitting, by the first user equipment, the new authorization certificate and the digital contents to the second user equipments to instruct the second user equipments to share the digital contents in accordance with the new authorization certificate.

### RELATED APPLICATIONS

This application is based upon and claims the benefit of priority from Chinese Patent Application No. 201110448508.4, filed Dec. 28, 2011, the entire contents of which are incorporated herein by reference.

### FIELD

The present invention relates to the field of communication technologies and, particularly, to a digital right management method, apparatus, and system.

### BACKGROUND

Digital Right Management (DRM) technologies are generally used to protect electronic books, digital movies, digital music, pictures, software and other digital contents by means of a series of software and hardware technologies. DRM may protect copyright of digital contents with the use of a digital authorization certificate, that is, a user obtaining copyrighted contents has to obtain the corresponding digital authorization certificate and use the digital contents in accordance with use right items granted in the digital authorization certificate. One practice is to authorize each user individually and to bind protected digital contents with a device currently used by the user so that the obtained digital contents can be used only on the bound device.

However, there have been a variety of devices used by a user along with the constant development of electronic devices and network application technologies, and particularly a user typically possesses a plurality of devices, e.g., a Personal Computer (PC), a notebook computer, a tablet computer, a smart mobile phone, and other devices so that there is a constantly growing demand of the user for the use of protected digital contents, and it is typically desirable to use the protected digital contents on the plurality of devices. Thus how to enable protected digital contents to be used among a plurality of devices has become an issue.

### SUMMARY

According to a first aspect of the present disclosure, there is provided a digital right management method, comprising: generating, by a first user equipment having access right to shared digital contents, a common public key based on one or more public keys of one or more second user equipments intended to share the digital contents, respectively; encrypting, by the first user equipment, a key of the digital contents with the common public key to generate a ciphertext of the key of the digital contents; generating, by the first user equipment, from the ciphertext a new authorization certificate corresponding to the digital contents; and transmitting, by the first user equipment, the new authorization certificate and the digital contents to the second user equipments to instruct the second user equipments to share the digital contents in accordance with the new authorization certificate.

According to a second aspect of the present disclosure, there is provided a first user equipment, comprising: a common public key determining module configured to generate a common public key based on one or more public keys of one or more second user equipments intended to share digital contents, respectively; a ciphertext generating module coupled to the common public key determining module and configured to encrypt a key of the digital contents with the common public key, to generate a ciphertext of the key of the digital contents; an authorization certificate determining module coupled to the ciphertext generating module and configured to generate from the ciphertext a new authorization certificate corresponding to the digital contents; and an authorization certificate transmitting module coupled to the authorization certificate determining module and configured to transmit the new authorization certificate and the digital contents to the second user equipments to instruct the second user equipments to share the digital contents in accordance with the new authorization certificate.

According to a third aspect of the present disclosure, there is provided a digital right management method, comprising: generating, by a server, a common public key from one or more public keys of one or more second user equipments intended to share digital contents, respectively; encrypting, by the server, a key of the digital contents with the common public key to generate a ciphertext of the key of the digital contents; generating, by the server, from the ciphertext a new authorization certificate corresponding to the digital contents; and transmitting, by the server, the new authorization certificate to the second user equipments through a first user equipment which has access right to the digital contents to instruct the second user equipments to share the digital contents in accordance with the new authorization certificate.

According to a fourth aspect of the present disclosure, there is provided a digital right management server, comprising: a common public key generating module configured to generate a common public key from one or more public keys of one or more second user equipments intended to share digital contents, respectively; an encrypting module coupled to the common public key generating module and configured to encrypt a key of the digital contents with the common public key to generate a ciphertext of the key of the digital contents; an authorization certificate generating module coupled to the encrypting module and configured to generate from the ciphertext a new authorization certificate corresponding to the digital contents; and a transmitting module coupled to the authorization certificate generating module and configured to transmit the new authorization certificate to the second user equipments through a first user equipment having access right to the digital contents, to instruct the second user equipments to share the digital contents in accordance with the new authorization certificate.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a general structure of a digital right management system, according to an exemplary embodiment.

FIG. 2 illustrates a block diagram of a digital right management system, according to an exemplary embodiment.

FIG. 3 illustrates a block diagram of a first user equipment in a digital right management system, according to an exemplary embodiment.

FIG. 4 illustrates a block diagram of a server in a digital right management system, according to an exemplary embodiment.

FIG. 5 illustrates a block diagram of a second user equipment in a digital right management system, according to an exemplary embodiment.

FIG. 6 illustrates a flowchart of a digital right management method performed by a first user equipment, according to an exemplary embodiment.

FIG. 7 illustrates a flowchart of a digital right management method performed by a server, according to an exemplary embodiment.

FIG. 8 illustrates a flowchart of a digital right management method performed by a second user equipment, according to an exemplary embodiment.

FIG. 9 illustrates a flowchart of a digital right management method performed by a system, according to an exemplary embodiment.

FIG. 10 illustrates a block diagram of a digital right management system, according to an exemplary embodiment.

FIG. 11 illustrates a block diagram of a server in a digital right management system, according to an exemplary embodiment.

FIG. 12 illustrates a flowchart of a digital right management method performed by a server, according to an exemplary embodiment.

FIG. 13 illustrates a flowchart of a digital right management method performed by a system, according to an exemplary embodiment.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

In exemplary embodiments, one or more modules disclosed in this disclosure may be implemented via one or more processors executing software programs for performing functionalities. In some embodiments, one or more of the disclosed modules are implemented via one or more hardware modules executing firmware for performing functionalities. In some embodiments, one or more of the disclosed modules include storage media for storing data, or software or firmware programs executed by the modules.

In exemplary embodiments, a server or a first user equipment which has shared digital contents, such as having access right to the digital contents, may generate a new authorization certificate from a public key of a second user equipment intended to share the digital contents and transmits the new authorization certificate to the second user equipment so that the second user equipment can share the corresponding digital contents in accordance with the received new authorization certificate, thus adding a new device to share protected digital contents in the course of using the protected digital contents.

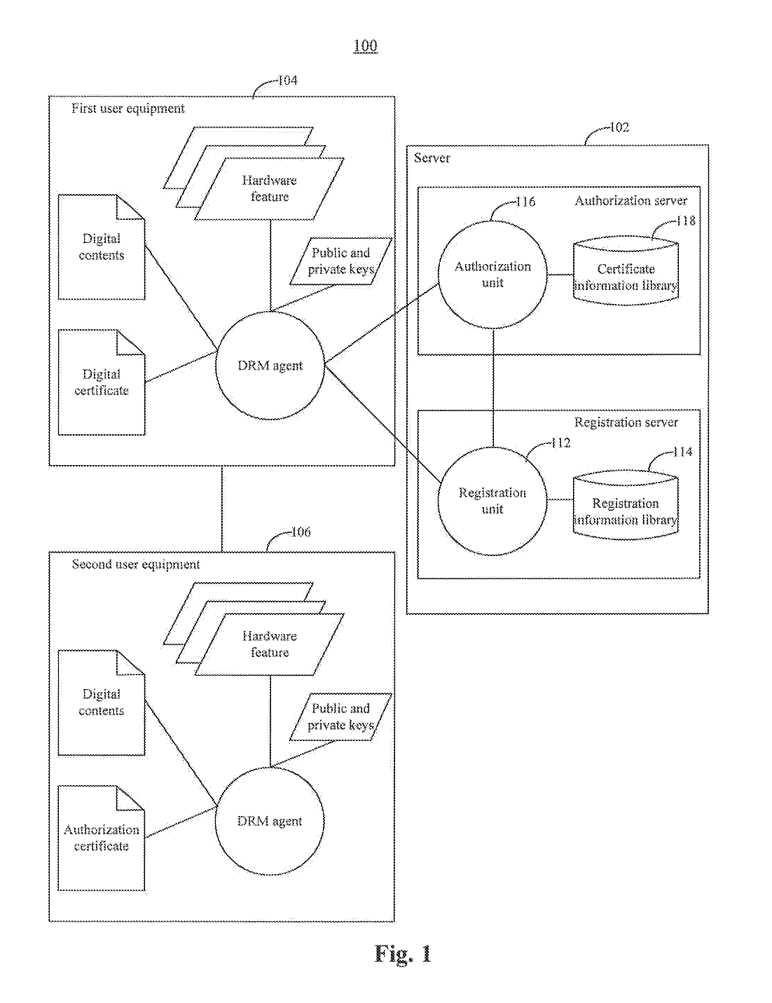

FIG. 1 illustrates a general structure of a digital right management system 100, according to an exemplary embodiment. Referring to FIG. 1, the system 100 may include a server 102, a first user equipment 104 which has shared digital contents, such as having access right to the digital contents, and a second user equipment 106 intended to share the digital contents. The first user equipment 104 and the second user equipment 106 may each be a Personal Computer (PC), a notebook computer, a portal reader, a tablet computer, a mobile phone with a reading function, etc., and may communicate with each other.

The first user equipment 104 may include a public key and a corresponding private key, and the second user equipment 106 may also include a public key and a corresponding private key. The first user equipment 104 and the second user equipment 106 may also include digital contents, authorization certificate(s), DRM agent(s), and hardware feature(s). A DRM agent may be a module that a user equipment uses to manage digital rights based on public and private key information, hardware feature(s), authorization certificate(s), and digital content(s). The DRM agent may also communication with server 102 to manage digital rights. The server 102 may be a server with an authorization processing function and a registration processing function, or two or more servers independent from each other, e.g., an authorization server and a registration server. The authorization server and the registration server may communicate with each other.

Referring to FIG. 1, before adding a new user equipment to share digital contents, a user may select as needed user equipments intended to use the digital contents, such as the second user equipment 106, register the selected user equipments with a registration unit 112 of the server 102 provided by an operator of the digital contents and download selected digital contents onto the respective selected user equipments.

After registering the selected user equipments, the registration unit 112 of the server 102 may store registration information including equipment identifiers of all the selected user equipments and user identity information respectively in a registration information library 114.

The selected user equipments may each transmit a request to an authorization unit 116 of the server 102 to apply for an authorization certificate of the digital contents. Upon reception of the request transmitted from any selected user equipment, the authorization unit 116 of the server 102 may obtain a public key of the selected user equipment. The authorization unit 116 of the server 102 may further encrypt a key of the digital contents with the public key of the selected user equipment to generate a ciphertext of the key of the digital contents, generate an authorization certificate from the ciphertext of the key of the digital contents to thereby bind the digital contents with the selected user equipment, store the generated authorization certificate in a certification information library 118 and also transmit the generated authorization certificate to the selected user equipment. In one exemplary embodiment, the authorization certificate may include at least a digital Content IDentifier (CID), a right item to indicate a use right of the user for the digital contents, a signature value to verify the authorization certificate for validity, and the ciphertext of the key of the digital contents. If a plurality of user equipments are selected, for each selected user equipment, the server 102 may generate an authorization certificate corresponding to the selected user equipment from a public key of that user equipment, that is, each selected user equipment may correspond to one authorization certificate. Alternatively and/or additionally, the server 102 may generate an authorization certificate from a plurality of public keys of all of the selected user equipments, respectively, that is, all of the selected user equipments may correspond to one authorization certificate.

Upon reception of the authorization certificate transmitted from the authorization unit 116 of the server 102, the user equipment which has shared the digital contents, e.g., the first user equipment 104, may decrypt the ciphertext of the key of the digital contents in the authorization certificate of the digital contents with its own private key through a client's DRM agent to obtain the key of the digital contents, and further access the digital contents with the key of the digital contents and in accordance with the corresponding right item in the authorization certificate.

Embodiments of the invention provide a digital right management method, apparatus, and system so that the user can add a new user equipment to share digital contents in the course of using a user equipment which has shared the digital contents to access the digital contents. It shall be noted if there are a plurality of user equipments which have shared the digital contents, the user may select the first user equipment 104 from one of those which are able to interact with both the server 102 and the second user equipment 106 intended to share the digital contents.

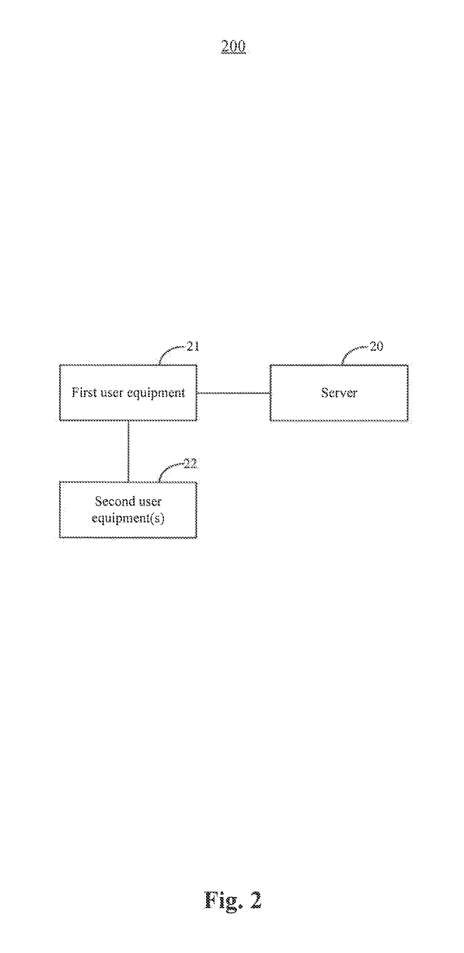

FIG. 2 illustrates a block diagram of the digital right management system 100 (FIG. 1), according to an exemplary embodiment. Referring to FIG. 2, the system 200 may include a server 20, a first user equipment 21, and one or more second user equipments 22.

In exemplary embodiments, the server 20 may be configured to receive a sharing request, including a generated digest value, transmitted from the first user equipment 21, to verify the sharing request, to generate a signature value from the digest value after the verification of the sharing request succeeds, and to transmit the generated signature value to the first user equipment 21.

In exemplary embodiments, the first user equipment 21 may be configured to generate a common public key from a plurality of public keys of all of the second user equipments 22 intended to share digital contents, to encrypt a key of the digital contents with the common public key to generate a ciphertext of the key of the digital contents, to generate from the ciphertext a new authorization certificate corresponding to the digital contents, and to transmit the new authorization certificate and the digital contents to the second user equipments 22 to instruct the second user equipments 22 to share the digital contents in accordance with the new authorization certificate.

In exemplary embodiments, the second user equipments 22 may each be configured to receive the new authorization certificate and the corresponding digital contents transmitted from the first user equipment 21, and to decrypt the ciphertext of the key of the digital contents in the new authorization certificate with a private key of the second user equipment 22, and to obtain the key of the digital contents and further access the digital contents corresponding to the new authorization certificate.

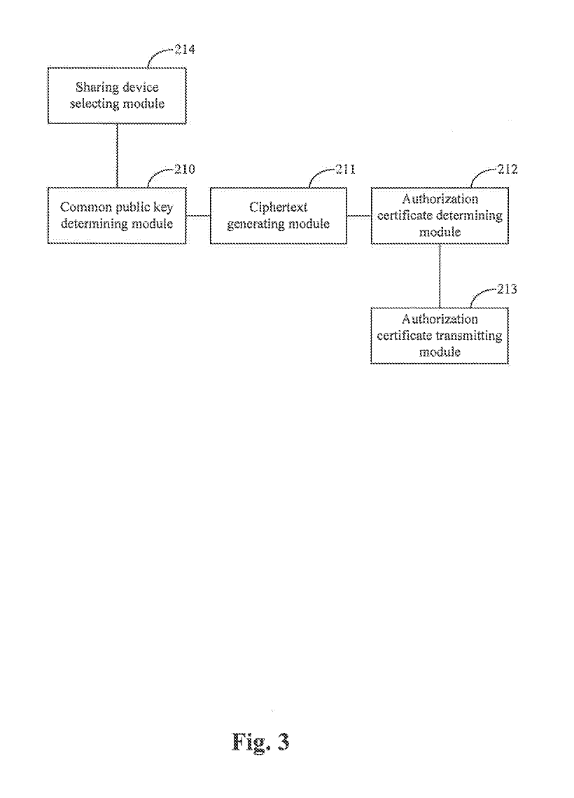

FIG. 3 illustrates a block diagram of the first user equipment 21 in the digital right management system 200 (FIG. 2), according to an embodiment. Referring to FIGS. 2 and 3, the first user equipment 21 may include a common public key determining module 210, a ciphertext generating module 211, an authorization certificate determining module 212, an authorization certificate transmitting module 213, and a sharing device selecting module 214.

In exemplary embodiments, the common public key determining module 210 may be configured to generate a common public key from a plurality of public keys of all the second user equipments 22 intended to share digital contents, respectively. If there is one second user equipment 22, the generated common public key may be a public key of the second user equipment 22. If there are a plurality of second user equipments 33, the common public key may be generated from a plurality of public keys of all the second user equipments in a full public key broadcast encryption algorithm.

In exemplary embodiments, the ciphertext generating module 211 may be configured to encrypt a key of the digital contents by the common public key to generate a ciphertext of the key of the digital contents. The authorization certificate determining module 212 may be configured to generate from the ciphertext a new authorization certificate corresponding to the digital contents. The authorization certificate transmitting module 213 may be configured to transmit the new authorization certificate and the digital contents to the second user equipments 22 to instruct the second user equipments 22 to share the digital contents in accordance with the new authorization certificate.

In exemplary embodiments, the common public key determining module 210 may also generate the common public key from a public key of the first user equipment 21 and the public keys of all of the second user equipments 22. For example, a common public key of a set of devices composed of the first user equipment 21 and all the second user equipments 22 may be generated from the public key of the first user equipment 21 and the public keys of all of the second user equipments 22 in a full public key broadcast encryption algorithm.

The authorization certificate determining module 212 may be further configured to replace an original authorization certificate of the first user equipment 21 with the new authorization certificate corresponding to the digital contents after generating the new authorization certificate from the ciphertext.

In exemplary embodiments, the authorization certificate determining module 212 may be configured to determine a digest value from the generated ciphertext and an original authorization certificate corresponding to the digital contents, to transmit data including the digest value to the server 20, to receive from the server 20 a signature value generated from the digest value, and to generate the new authorization certificate from the received signature value, the ciphertext of the key of the digital contents, and the original authorization certificate. The transmitted data may include user identity information, a CID of the digital contents, an equipment identifier of the first user equipment, an equipment identifier of the second user equipment, the generated ciphertext and digest value, etc.

In exemplary embodiments, the authorization certificate determining module 212 may be further configured to perform a hash operation on the generated ciphertext and a right item in the original authorization certificate corresponding to the digital contents to determine the digest value.

In exemplary embodiments, in the course of interaction between the first user equipment 21 and the server 20, a part or all of transmission data may be encrypted to protect the transmission data for security. For example, the first user equipment 21 may encrypt the equipment identifier HW₀ of the first user equipment 21, the equipment identifier HW₁ of the second user equipment 22, and the generated ciphertext SK_{c} by a public key PubK_{RI} of the server 20 to obtain encrypted data Reqₛ, that is, E(HW₀, HW₁, SK_{c}|PubK_{Rf})=Reqₛ, and transmit the user identity information, the CID of the digital contents, the digest value H_{SK}, and the encrypted data Reqₛ to the server 20.

In exemplary embodiments, the sharing device selecting module 214 may be configured to select at least one of user equipments currently connected with the first user equipment 21 as the second user equipment 22, and to obtain the public key and the equipment identifier of the second user equipment 22. Additionally and/or alternatively, the sharing device selecting module 214 may be configured to select at least one of user equipments transmitting a request to the first user equipment 21 for sharing the digital contents as the second user equipment 22, and to obtain the equipment identifier and the public key of the second user equipment 22. The first user equipment 21 and the second user equipment 22 may communicate with each other through Bluetooth, infrared or WIFI.

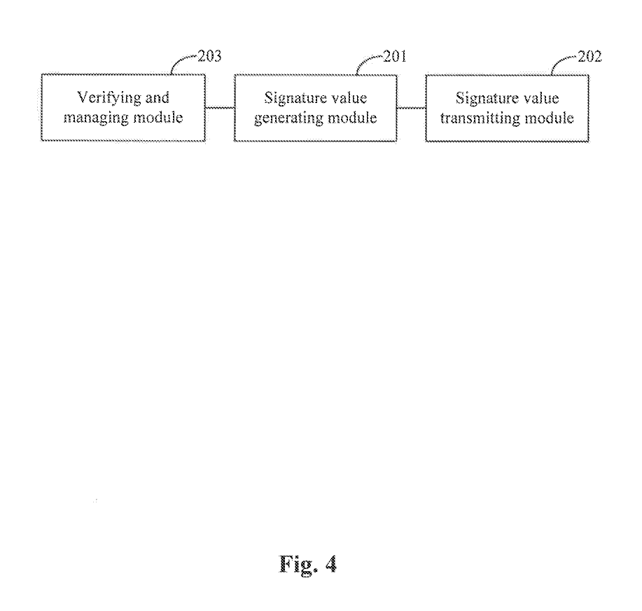

FIG. 4 illustrates a block diagram of the server 20 in the digital right management system 200 (FIG. 2), according to an exemplary embodiment. Referring to FIGS. 2 and 4, the server 20 may include a signature value generating module 201, a signature value transmitting module 202, and a verifying and managing module 203.

In exemplary embodiments, the signature value generating module 201 may be configured to receive data, including a generated digest value, transmitted from the first user equipment 21, and to generate a signature value from the digest value.

For example, the signature value generating module 201 may sign the digest value using an encryption algorithm based on an RSA public key to obtain the signature value for verifying an authorization certificate for validity. Other exemplary signing algorithms may include EIGamal, Fiat-Shamir, Guillou-Quisquarter, Schnorr, Ong-Schnorr-Shamir digital signing algorithm, a Des/DSA elliptical-curve digital signing algorithm, a finite-automatic-machine digital signing algorithm, etc.

In exemplary embodiments, the signature value transmitting module 202 may be configured to transmit the generated signature value to the first user equipment 21.

In exemplary embodiments, the verifying and managing module 203 may be configured to determine that a sum of a number of user equipments which have shared the digital contents (i.e., user equipments which have been bound with the digital contents) and a number of user equipments intended to share the digital contents (i.e., second user equipments) is not larger than a maximum allowable number of sharing devices that can share the digital contents. For example, the number of user equipments which have shared the digital contents may be determined by the server 20 from the number of user equipments using an authorization certificate corresponding to the digital contents or from the number of user equipments bound with the digital contents in a registration unit, and the number of user equipments intended to share the digital contents may be determined based on the number of obtained equipment identifiers of second user equipments 22.

In exemplary embodiments, the server 20 may determine the digital contents corresponding to a CID in the received data transmitted from the first user equipment 21 and obtains the maximum allowable number N of sharing devices corresponding to the digital contents (where N is a positive integer). The server 20 also may determine the sum of the number of user equipments which have shared the digital contents and the number of second user equipments 22 currently applying for sharing and verifies whether sharing of the digital contents by a user has reached the maximum allowable number N of sharing devices corresponding to the digital contents (where N is a positive integer). If the sum of the number of user equipments which have shared the digital contents and the number of second user equipments 22 currently applying for sharing is not larger than the maximum allowable number N of sharing devices corresponding to the digital contents, the verification succeeds, and the sharing request may be determined to be valid. If the sum of the number of user equipments which have shared the digital contents and the number of second user equipments 22 currently applying for sharing is larger than the maximum allowable number N of sharing devices corresponding to the digital contents, the verification fails, and the sharing request of the first user equipment 21 may be rejected.

In exemplary embodiments, when the sum of the number of user equipments which have shared the digital contents and the number of second user equipments 22 is larger than the maximum allowable number N of sharing devices corresponding to the digital contents, the server 20 may reject the sharing request and notifies the first user equipment 21 of the remaining number of sharing devices of the digital contents (that is, the maximum allowable number N of sharing devices corresponding to the digital contents minus the number of user equipments which have shared the digital contents). The first user equipment 21 may re-determine the number of second user equipments 22 intended to share the digital contents from the received remaining number of sharing devices of the digital contents so that the sum of the number of user equipments which have shared the digital contents and the number of second user equipments 22 is not larger than the maximum allowable number of sharing devices corresponding to the digital contents.

In exemplary embodiments, when the sum of the number of user equipments 21 which have shared the digital contents and the number of second user equipments 22 is larger than the maximum allowable number of sharing devices corresponding to the digital contents, the server 20 may select a few of the second user equipments 22 so that the sum of the number of user equipments which have shared the digital contents and the number of selected second user equipments is not larger than the maximum allowable number of sharing devices corresponding to the digital contents.

In exemplary embodiments, the verifying and managing module 203 may be further configured to verify the identity of the first user equipment 21 against user identity information and an equipment identifier of the first user equipment 21 to determine whether the first user equipment 21 is a legal possessor of the authorization certificate, before determining that the sum of the number of user equipments which have shared the digital contents and the number of second user equipments 22 is not larger than the maximum allowable number N of sharing devices corresponding to the digital contents.

In one exemplary embodiment, the received user identity information and the equipment identifier of the first user equipment 21 may be compared with data information stored in the registration information library. If they are consistent, the verification succeeds, that is, the first user equipment 21 may be determined to be a legal possessor of the authorization certificate. If they are inconsistent, the verification fails, that is, the first user equipment 21 may be determined not to be a legal possessor of the authorization certificate, and the sharing request may be rejected.

In exemplary embodiments, the verifying and managing module 203 may be further configured to verify the digest value H_{SK} generated by the first user equipment 21 after determining that the sum of the number of user equipments which have shared the digital contents and the number of second user equipments 22 is not larger than the maximum allowable number N of sharing devices corresponding to the digital contents.

For example, a ciphertext SK_{c} of a key of the digital contents in the sharing request may be obtained, an original authorization certificate corresponding to the first user equipment 21 may be obtained from the certification library, and a hash operation may be re-performed on the ciphertext SK_{c} and a right item P′ in the original authorization certificate to obtain a comparison digest value H′_{SK}, i.e., H(SK_{c}+P′)=H′_{SK}. H′_{SK} and H_{SK} may then be compared to determine consistency. If they are consistent, verification of the digest value may succeed. If they are inconsistent, the sharing request may be rejected.

In exemplary embodiments, the verifying and managing module 203 may be further configured, after the verification of the digest value succeeds, to register all of the second user equipments 22 according to their respective equipment identifiers and to store registration information of the second user equipments 22 in the registration information library.

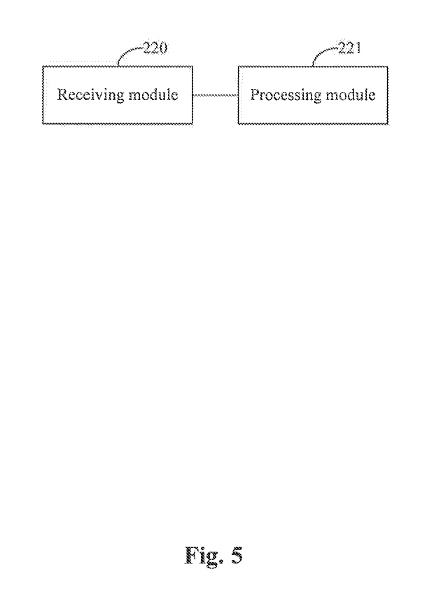

FIG. 5 illustrates a block diagram of one second user equipment 22 in the digital right management system 200 (FIG. 2), according to an exemplary embodiment. Referring to FIGS. 2 and 5, the second user equipment 22 may include a receiving module 220 and a processing module 221.

In exemplary embodiments, the receiving module 220 may be configured to receive a new authorization certificate and corresponding digital contents transmitted from the first user equipment 21. The processing module 221 may be configured to decrypt a ciphertext of a key of the digital contents in the new authorization certificate with a private key of the second user equipment 22 to obtain the key of the digital contents and further access the digital contents corresponding to the new authorization certificate.

For example, upon reception of the new authorization certificate transmitted from the first user equipment 21, the second user equipment 22 first may verify a signature value in the new authorization certificate for validity against an identity certificate of the server 20, and may further decrypt the ciphertext of the key of the digital contents in the new authorization certificate with its own equipment key to thereby share the digital contents, after determining the signature value to be valid.

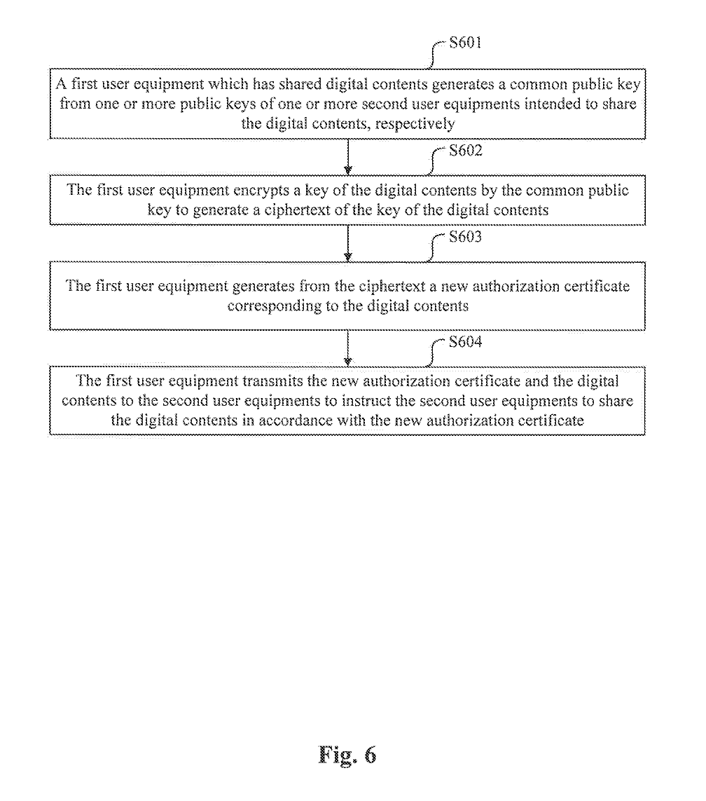

FIG. 6 illustrates a flowchart of a digital right management method performed by a first user equipment, such as the first user equipment 21 in the digital right management system 200 (FIG. 2), according to an exemplary embodiment. Referring to FIG. 6, in step S601, the first user equipment which has shared digital contents may generate a common public key from one or more public keys of one or more second user equipments intended to share the digital contents. In step S602, the first user equipment 21 may encrypt a key of the digital contents by the common public key to generate a ciphertext of the key of the digital contents. In step S603, the first user equipment may generate from the ciphertext a new authorization certificate corresponding to the digital contents. In step S604, the first user equipment 21 may transmit the new authorization certificate and the digital contents to the second user equipments 22 to instruct the second user equipments to share the digital contents as per the new authorization certificate.

In one exemplary embodiment, the common public key may also be generated in step S601 by generating a common public key from a public key of the first user equipment 21 and the public keys of all of the second user equipments 22. Correspondingly after step S603, the first user equipment 21 may replace an original authorization certificate corresponding to the first user equipment with the new authorization certificate.

In exemplary embodiments, generating the new authorization certificate in step S603 may include: the first user equipment may determine a digest value from the generated ciphertext and an original authorization certificate corresponding to the digital contents, transmit a sharing request including the digest value to the server and receive from the server a signature value generated from the digest value. The first user equipment may generate the new authorization certificate from the signature value, the ciphertext and the original authorization certificate.

In exemplary embodiments, before generating the ciphertext of the key of the digital contents in step S601, the first user equipment may select at least one of user equipments currently connected with the first user equipment as the second user equipment, and obtains a public key and an equipment identifier of the second user equipment. Additionally and/or alternatively, the first user equipment may select at least one of user equipments transmitting a request to the first user equipment for sharing the digital contents as the second user equipment, and obtain an equipment identifier and a public key of the second user equipment. For example, the first user equipment and the second user equipment may communicate with each other through Bluetooth, infrared or Wireless Fidelity (WIFI).

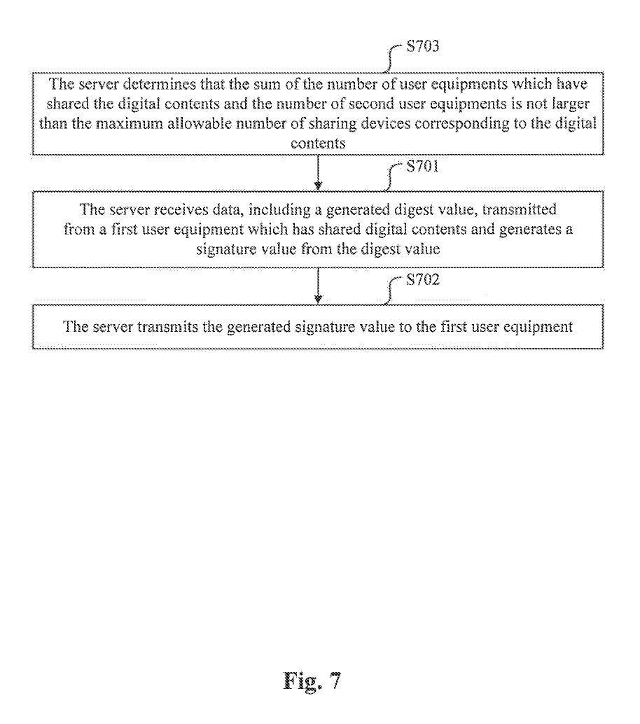

FIG. 7 illustrates a flowchart of a digital right management method performed by a server, such as the server 20 in the digital right management system 200 (FIG. 2), according to an exemplary embodiment. Referring to FIG. 7, in step S701, the server may receive data, including a generated digest value, transmitted from a first user equipment which has shared digital contents and generates a signature value from the digest value. In step S702, the server may transmit the generated signature value to the first user equipment. Before the server may generate the signature value in step S701, the server may determine that the sum of the number of user equipments which have shared the digital contents and the number of second user equipments is not larger than the maximum allowable number of sharing devices of the digital contents (step S703).

For example, the sum of the number of user equipments which have shared the digital contents may be determined from authorization information or registration information stored in the server, and the number of second user equipments may be determined from the number of identifiers of second user equipments.

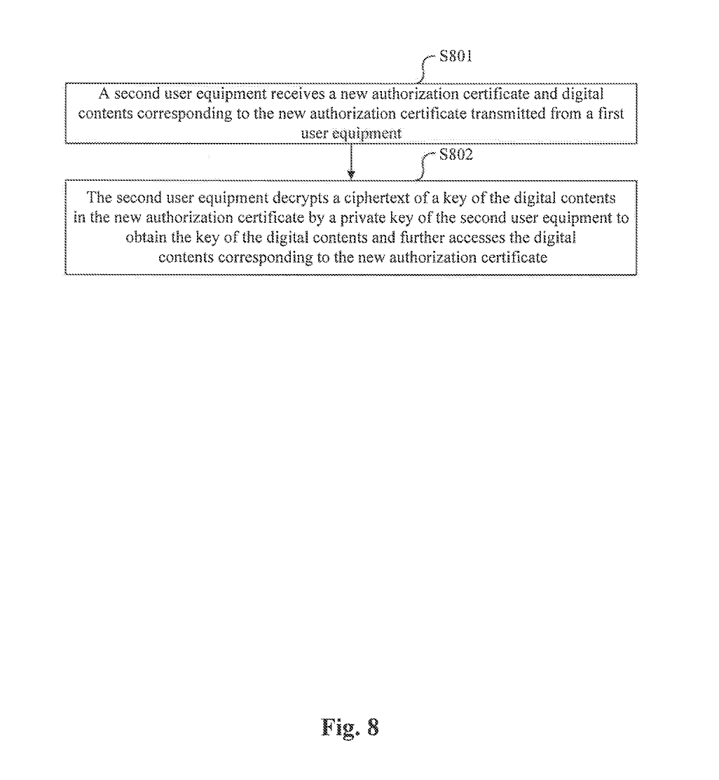

FIG. 8 illustrates a flowchart of a digital right management method performed by a second user equipment, such as the second user equipment 22 in the digital right management system 200 (FIG. 2), according to an exemplary embodiment. Referring to FIG. 8, in step S801, the second user equipment may receive a new authorization certificate and digital contents corresponding to the new authorization certificate transmitted from a first user equipment. In step S802, the second user equipment may decrypt a ciphertext of a key of the digital contents in the new authorization certificate by a private key of the second user equipment to obtain the key of the digital contents and further access the digital contents corresponding to the new authorization certificate.

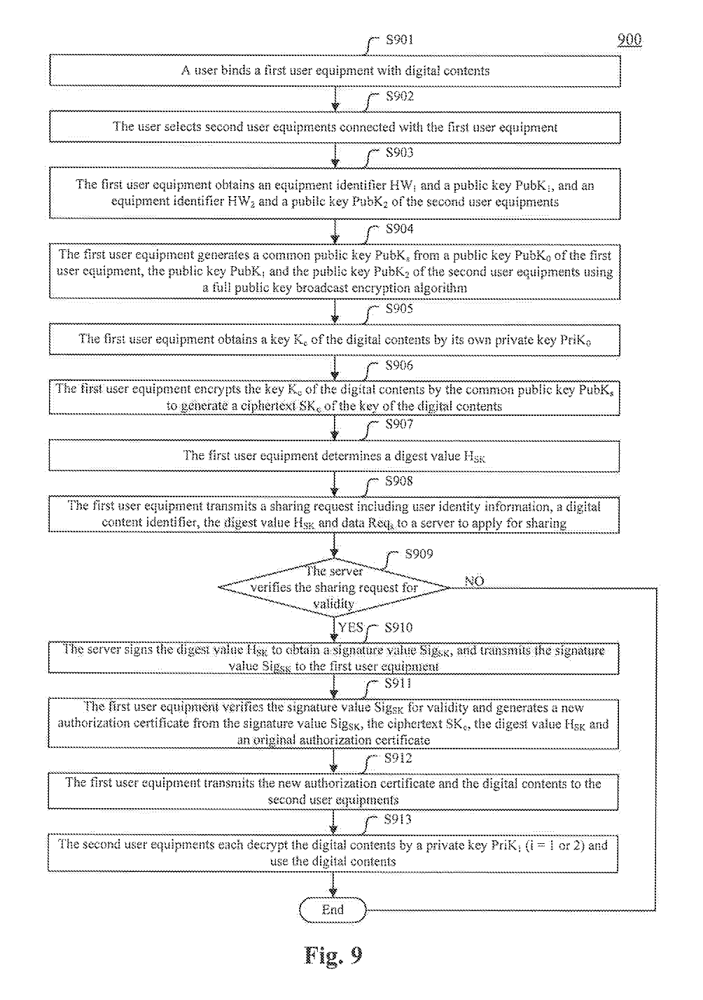

FIG. 9 illustrates a flowchart of a digital right management method 900 performed by the system 200 (FIG. 2), according to an exemplary embodiment. Referring to FIGS. 2 and 9, in the method 900, the first user equipment 21 may generate a ciphertext of a key of digital contents with a public key of the first user equipment 21 and one or more public keys of the one or more second user equipments 22. As illustrated in FIG. 9, the method may include the following steps:

Step S901: A user may bind the first user equipment 21 with digital contents;

Step S902: The user may select second user equipments 22-D₁ and 22-D₂ connected with the first user equipment 21;

Step S903: The first user equipment 21 may obtain an equipment identifier HW₁ and a public key PubK₁ of the second user equipment 22-D₁, and an equipment identifier HW₂ and a public key PubK₂ of the second user equipment 22-D₂;

Step S904: The first user equipment 21 may generate a common public key PubKₛ from a public key PubK₀ of the first user equipment 21, the public key PubK₁ of the second user equipment 22-D₁ and the public key PubK₂ of the second user equipment 22-D₂ using a full public key broadcast encryption algorithm, i.e., FPKBE (PubK₀, PubK₁, PubK₂)=PubKₛ;

Step S905: The first user equipment 21 may obtain a key K_{c} of the digital contents by its own private key PriK₀;

Step S906: The first user equipment 21 may encrypt the key K_{c} of the digital contents with the common public key PubKₛ to generate a ciphertext SK_{c} of the key of the digital contents, i.e., E (K_{c}|PubKₛ)=SK_{c};

Step S907: The first user equipment 21 may determine a digest value H_{SK};

Step S908: The first user equipment 21 may transmit a sharing request including user identity information, a digital content identifier, the digest value H_{SK} and data Reqₛ to the server 20 to apply for sharing;

Step S909: The server 20 may verify the received sharing request for validity; and if the verification succeeds, the process may go to step S910; otherwise, the server may reject the sharing request, and the process may end;

Step S910: The server 20 may sign the digest value H_{SK} to obtain a signature value Sig_{SK}, and transmit the signature value Sig_{SK} to the first user equipment 21;

Step S911: The first user equipment 21 may verify the signature value Sig_{SK} for validity and generates a new authorization certificate from the signature value Sig_{SK}, the ciphertext SK_{c}, the digest value H_{SK} and an original authorization certificate;

Step S912: The first user equipment 21 may transmit the new authorization certificate and the digital contents to the second user equipments 22-D₁ and 22-D₂; and

Step S913: The second user equipment 22-Dᵢ (i=1 or 2) may decrypt the digital contents by a private key PriKᵢ (i=1 or 2) and use the digital contents, and the process ends.

In exemplary embodiments, the first user equipment 21 which has shared digital contents generates a common public key from public keys of all of the second user equipments 22 intended to share the digital contents, may generate a ciphertext of a key of the digital contents and further a new authorization certificate from the generated common public key, and transmit the new authorization certificate and the digital contents to each second user equipment 22 so that the second user equipments 22 may decrypt the ciphertext in the received new authorization certificate by their respective own private keys and further share the digital contents, thus enabling a user to add a new user equipment to share digital contents in the course of using the digital contents. Therefore, the user may be enabled to add one or more new user equipments dynamically to share the digital contents in response to a change in type or use environment of the digital contents in the course of using the digital contents.

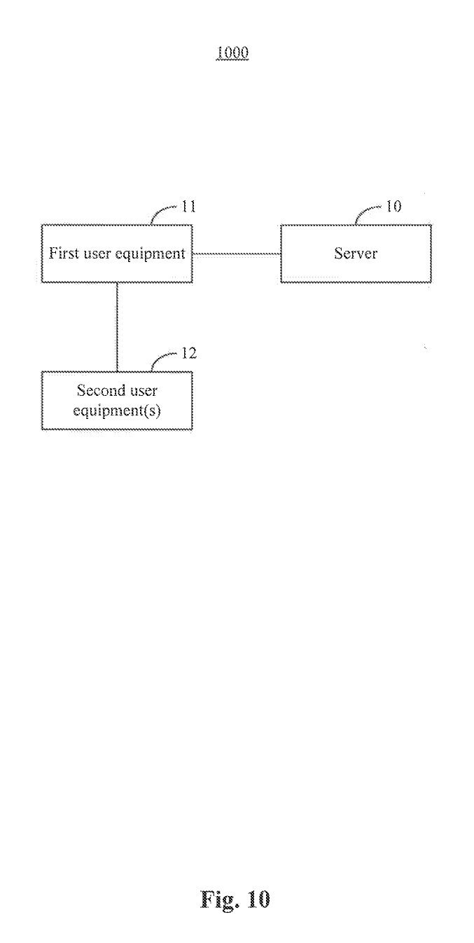

FIG. 10 illustrates a block diagram of a digital right management system 1000, according to an exemplary embodiment. Referring to FIG. 10, the system 1000 may include a server 10, a first user equipment 11 which has shared digital contents, and one or more second user equipments 12 intended to share the digital contents.

In exemplary embodiments, the server 10 may be configured to generate a common public key from one or more public keys of the one or more second user equipments 12 intended to share digital contents, respectively, to encrypt a key of the digital contents by the common public key to generate a ciphertext of the key of the digital contents, to generate from the ciphertext a new authorization certificate corresponding to the digital contents, and to transmit the new authorization certificate to the second user equipments 12 through the first user equipment 11 to instruct the second user equipments 12 to share the digital contents in accordance with the new authorization certificate.

In exemplary embodiments, the first user equipment 11 may be configured to obtain equipment identifiers and the public keys of the second user equipments 12, to transmit the equipment identifiers and the public keys of the second user equipments 12 to the server 10, and to transmit the new authorization certificate generated by the server 10 and the digital contents to the second user equipments 12.

In exemplary embodiments, the second user equipments 12 may each be configured to receive the new authorization certificate and the corresponding digital contents transmitted from the first user equipment 11, and to decrypt the ciphertext of the key of the digital contents in the new authorization certificate by a private key of the second user equipment 12 to obtain the key of the digital contents and further access the digital contents corresponding to the new authorization certificate.

In exemplary embodiments, before adding a new user equipment to share digital contents, a user may firstly bind selected user equipments with the digital contents over a network in the same binding process as the digital right management system 200 illustrated in FIG. 2.

In exemplary embodiments, the first user equipment 11 may be configured to select at least one of user equipments connected therewith as the second user equipment 12 intended to share the digital contents. For example, the first user equipment 11 and the second user equipment 12 may communicate with each other through Bluetooth, infrared or WIFI. The first user equipment 11 may be also configured to obtain the equipment identifier and the public key of the second user equipment 12 in a communication protocol with the second user equipment 12; and to transmit data and a sharing request to the server 10. The transmitted data may include an equipment identifier and a public key of the first user equipment 11, the equipment identifier and the public key of the second user equipment 12, user identity information, and a CID of the digital contents.

In exemplary embodiments, in the course of interaction between the first user equipment 11 and the server 10, a part or all of transmission data may be encrypted to protect the transmission data for security. For example, the first user equipment 11 may encrypts the equipment identifier HW₀ of the first user equipment 11, and the equipment identifier HW₁ of the first user equipment 12 by a public key PubK_{RI} of the server 10 to obtain encrypted data Reqₛ, that is, E(HW₀, HW₁|PubK_{RI})=Reqₛ, and transmits the user identity information, the CID of the digital contents, and the encrypted data Reqₛ to the server 10.

Upon reception of the data information transmitted from the first user equipment 11, the server 10 may decrypt the encrypted data with its own private key PriK_{RI} and then perform a further verification operation to thereby ensure the security of the data.

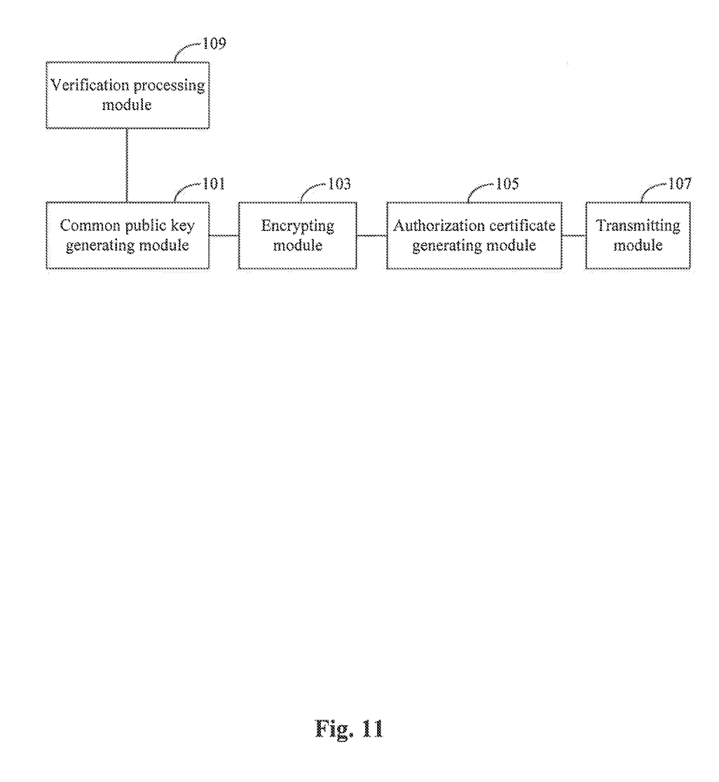

FIG. 11 illustrates a block diagram of the server 10 in the digital right management system 1000 (FIG. 10), according to an exemplary embodiment. Referring to FIGS. 10 and 11, the server 10 may include a common public key generating module 101, an encrypting module 103, an authorization certificate generating module 105, a transmitting module 107, and a verification processing module 109.

In exemplary embodiments, the common public key generating module 101 may be configured to generate a common public key from public keys of all of the second user equipments 22 intended to share digital contents, respectively. If there is one second user equipment, the generated common public key may be a public key of the second user equipment. For a plurality of second user equipments, a common public key of a set of devices composed of the plurality of second user equipments may be generated from public keys of all the second user equipments using a full public key broadcast encryption algorithm.

In exemplary embodiments, the encrypting module 103 may be configured to encrypt a key of the digital contents by the common public key to generate a ciphertext of the key of the digital contents. The authorization certificate generating module 105 may be configured to generate from the ciphertext a new authorization certificate corresponding to the digital contents. The transmitting module 107 may be configured to transmit the new authorization certificate to the second user equipments 22 through the first user equipment 11 to instruct the second user equipments 22 to share the digital contents as per the new authorization certificate.

In exemplary embodiments, the common public key generating module 101 may also generate the common public key from a public key of the first user equipment 11 and the public key(s) of the second user equipment(s) 12. For example, a common public key of a set of devices composed of the first user equipment and all the second user equipments may be generated from the public key of the first user equipment and the public keys of all the second user equipments in a full public key broadcast encryption algorithm.

The authorization certificate generating module 105 may be further configured to replace an original authorization certificate of the first user equipment 11 with the new authorization certificate corresponding to the digital contents after generating the new authorization certificate from the ciphertext.

In exemplary embodiments, the verification processing module 109 may be configured to determine that a sum of a number of user equipments which have shared digital contents and a number of second user equipments is not larger than the maximum allowable number of sharing devices corresponding to the digital contents, using a verification process similar to that described above in connection with the verification processing module 203 of the server 20 (FIG. 4).

In exemplary embodiments, the verification processing module 109 may be further configured to verify the identity of the first user equipment 11 against user identity information and an equipment identifier of the first user equipment 11 to determine whether the first user equipment 11 is a legal possessor of the authorization certificate, before determining that the sum of the number of user equipments which have shared the digital contents and the number of second user equipments 12 is not larger than the maximum allowable number of sharing devices corresponding to the digital contents, using a verification process similar to that described above in connection with the verification processing module 203 of the server 20 (FIG. 4).

In exemplary embodiments, the verification processing module 109 may be further configured to register the second user equipments 12 according to equipment identifiers of the second user equipments 12 and store registration information of the second user equipments 12 in a registration information library, after determining that the sum of the number of user equipments which have shared the digital contents and the number of the second user equipments 12 is not larger than the maximum allowable number of sharing devices corresponding to the digital contents.

In exemplary embodiments, the authorization certificate generating module 105 may be configured to determine a digest value from the generated ciphertext and a right item in an original authorization certificate corresponding to the digital contents and to sign the digest value to obtain a signature value.

In one exemplary embodiment, after the ciphertext of the key of the digital contents is generated, an original authorization certificate may be obtained from the authorization information library, a right item may be extracted from the original authorization certificate, a hash operation may be performed on the right item and the ciphertext of the key of the digital contents to obtain a digest value, the generated digest value may be signed to obtain a signature value, and the new authorization certificate may be generated from the generated signature value, the generated ciphertext and the original authorization certificate.

The second user equipment 12 intended to share digital contents may transmit its own equipment identifier to the server 10 through the first user equipment 11 which is connected with the second user equipment 12 and which has shared the digital contents, and the new authorization certificate generated by the server 10 may be transmitted to the second user equipment 12 through the first user equipment 11. As a result, the second user equipment 12 may be added through the first user equipment 11 to share the digital contents regardless of whether or not the second user equipment 12 is a network device.

In exemplary embodiments, the second user equipment 12 may be implemented in a similar way to the second user equipment 22 illustrated in FIG. 5.

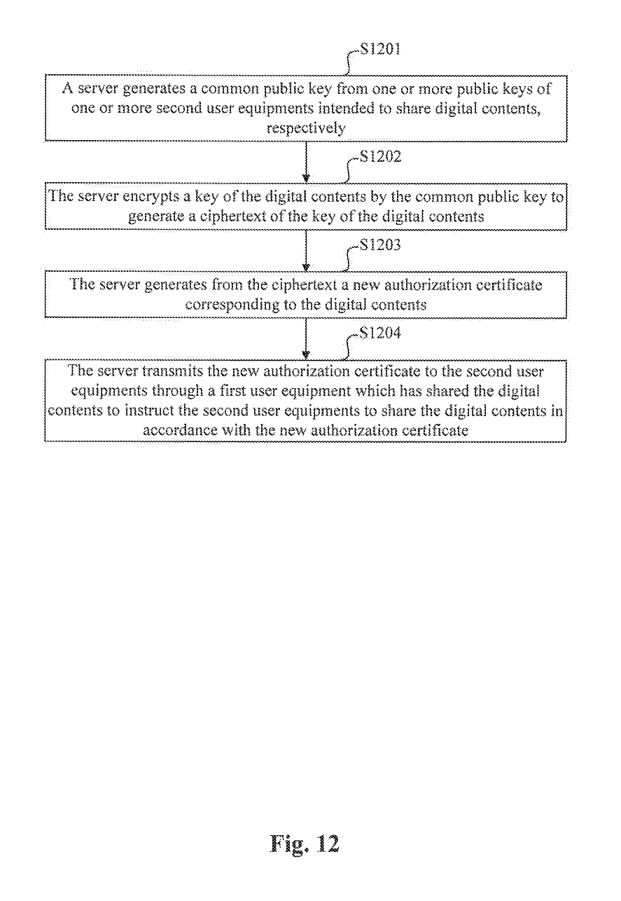

FIG. 12 illustrates a flowchart of a digital right management method 1200 performed by a server, such as the server 10 (FIG. 10), according to an exemplary embodiment. Referring to FIG. 12, in step S1201, the server may generate a common public key from one or more public keys of one or more second user equipments intended to share digital contents respectively. In step S1202, the server may encrypt a key of the digital contents by the common public key to generate a ciphertext of the key of the digital contents. In step S1203, the server may generate from the ciphertext a new authorization certificate corresponding to the digital contents. In step S1204, the server may transmit the new authorization certificate to the second user equipments through a first user equipment which has shared the digital contents, such as the first user equipment 11 (FIG. 10), to instruct the second user equipments to share the digital contents in accordance with the new authorization certificate.

In exemplary embodiments, the common public key may also be generated in step S1201 by generating a common public key from a public key of the first user equipment and the public keys of the second user equipments, respectively. The server may transmit the new authorization certificate to the first user equipment to instruct the first user equipment to replace an original authorization certificate corresponding to the first user equipment with the new authorization certificate.

In exemplary embodiments, the server may obtain the public key of the first user equipment and the public keys of the second user equipments by interacting with the first user equipment.

In exemplary embodiments, generating the new authorization certificate in step S1203 may include that the server may determine a digest value from the generated ciphertext and a right item in an original authorization certificate corresponding to the digital contents and may sign the digest value to obtain a signature value. For example, after generating the ciphertext of the key of the digital contents, the server may obtain the original authorization certificate from the authorization information library, extract the right item from the original authorization certificate, and perform a hash operation on the right item and the ciphertext of the key of the digital contents to obtain the digest value. The server then may sign the generated the digest value to obtain the signature value, and generate the new authorization certificate from the generated signature value, the generated ciphertext, and the original authorization certificate.

In step S1204, the server may transmit the new authorization certificate to the second user equipments through the first user equipment. In one exemplary embodiment, the server may transmit the generated new authorization certificate to the first user equipment, and the first user equipment may transmit the new authorization certificate and the digital contents to the second user equipments connected with the first user equipment to instruct the second user equipments share the digital contents as per the new authorization certificate.

In exemplary embodiments, the functional modules of the first user equipment 21 illustrated in FIG. 3 and of the first user equipment 11 of the second digital right management system illustrated in FIG. 10 can be integrated in a single user equipment, and different functional modules can be selected as needed for a user in the course of using the user equipment.

Since a first user equipment and a second user equipment can be interchanged in a different use environment, the first user equipment 21 illustrated in FIG. 3 can also include the functional modules of the second user equipment 22 illustrated in FIG. 5, and the first user equipment 11 illustrated in FIG. 10 can also include the functional modules of the second user equipment 22 illustrated in FIG. 5.

In exemplary embodiments, the functional modules of the server 10 illustrated in FIG. 11 and of the server 20 illustrated in FIG. 4 may be integrated in a single server, and different functional modules can be selected as needed for a user.

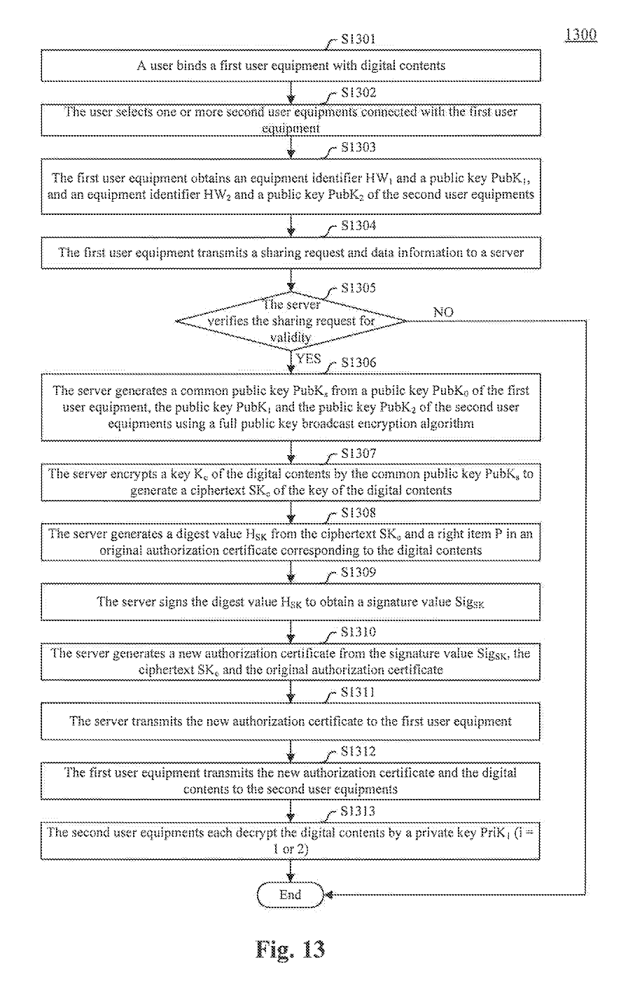

FIG. 13 illustrates a flowchart of a digital right management method 1300 performed by the system 1000 (FIG. 10), according to an exemplary embodiment. Referring to FIGS. 10 and 13, in the method 1300, the server 10 may generate a ciphertext of a key of digital contents by a public key of the first user equipment 11 and one or more public keys of the one or more second user equipments 12. As illustrated in FIG. 13, the method may include the following steps.

Step S1301: A user may bind the first user equipment 11 with digital contents;

Step S1302: The user may select second user equipments 12-D₁ and 12-D₂ connected with the first user equipment 11;

Step S1303: The first user equipment 11 may obtain an equipment identifier HW₁ and a public key PubK₁ of the second user equipment 12-D₁, and an equipment identifier HW₂ and a public key PubK₂ of the second user equipment 12-D₂;

Step S1304: The first user equipment 11 may transmit a sharing request and data to the server 10, and the data may include user identity information, a digital content identifier, a public key PubK₀ and an equipment identifier HW₀ of the first user equipment 11, the public key PubK₁ and the equipment identifier HW₁ of the second user equipment 12-D₁, and the public key PubK₂ and the equipment identifier HW₂ of the second user equipment 12-D₂;

Step S1305: The server may verify the sharing request for validity; and if the verification succeeds, the process goes to step S1306; otherwise, the server 10 may reject the sharing request, and the process may end;

Step S1306: The server 10 may generate a common public key PubKₛ from the public key PubK₀ of the first user equipment 11, the public key PubK₁ of the second user equipment 12-D₁ and the public key PubK₂ of the second user equipment 12-D₂ using a full public key broadcast encryption algorithm, i.e., FPKBE (PubK₀, PubK₁, PubK₂)=PubKₛ;

Step S1307: The server 10 may encrypt a key K_{c} of the digital contents by the common public key PubKₛ to generate a ciphertext SK_{c} of the key of the digital contents, i.e., E (K_{c}|PubKₛ)=SK_{c};

Step S1308: The server 10 may generate a digest value H_{SK} from the ciphertext SK_{c} and a right item P in an original authorization certificate corresponding to the digital contents;

Step S1309: The server 10 may sign the digest value H_{SK} to obtain a signature value Sig_{SK};

Step S1310: The server 10 may generate a new authorization certificate from the signature value Sig_{SK}, the ciphertext SK_{c}, and the original authorization certificate;

Step S1311: The server 10 may transmit the new authorization certificate to the first user equipment 11;

Step S1312: The first user equipment 11 may transmit the new authorization certificate and the digital contents to the second user equipments 12-D₁ and 12-D₂; and

Step S1313: The second user equipment 12-Dᵢ (i=1 or 2) decrypts the digital contents by a private key PriKᵢ (i=—or 2) and uses the digital contents, and the process ends.

The server 10 may generate the common public key from the public keys of the second user equipments 12 intended to share digital contents, respectively, generate a ciphertext of a key of the digital contents and further a new authorization certificate from the generated common public key, and transmit the new authorization certificate and the digital contents to the second user equipments 12 so that the second user equipments 12 can decrypt the ciphertext in the received new authorization certificate by their respective own private keys and further share the digital contents, thus enabling a user to add one or more new user equipments to share digital contents in the course of using the digital contents. As a result, the user may add one or more new user equipments dynamically to share the digital contents in response to a change in type or use environment of the digital contents in the course of using the digital contents.

Compared to the cases in which sharing digital contents among a plurality of user equipments is at a user-level granularity, that is, a server may limit the largest number of user equipments that can be registered for each user, and for different digital contents used by the user, the user can only select user equipment(s) from the registered user equipments to share the different digital contents, the present disclosure provides sharing digital contents among a plurality of user equipments at a digital content-level granularity, that is, for different digital contents used by each user, the largest numbers of user equipments sharing the respective digital contents are set respectively to enable the user to make flexible setting dependent upon the type of user equipment or the type of digital contents in the course of using the different digital contents. Since the number of user equipments sharing digital contents of each user is set for the digital contents instead of uniformly setting the number of sharing user equipments of the user, the flexibility of an authorization system and a good experience of the user can be further improved.

In exemplary embodiments, in the course of interaction of the first user equipment with the server, a part or all of contents in transmission data may be encrypted in order to protect user data for privacy. For example, the first user equipment may encrypt and encapsulate an equipment identifier, the ciphertext of the key of digital contents, and other data transmitted from the first user equipment with a public key of the server, and transmit an encryption and encapsulation result to the server. Upon reception of the encrypted data transmitted from the first user equipment, the server may decrypt the encapsulated information with its own private key and then performs a further verification operation on the data, thus ensuring the security of the data.

In exemplary embodiments, in the course of interaction between the first user equipment with the server, in order to improve the efficiency of sharing among devices, first the remaining number J of sharing devices of digital contents may be obtained from the server, and the first user equipment may determine the number n of second user equipments intended to share the digital contents from the number of received equipment identifiers of the second user equipments, intended to share the digital contents, transmitted from the second user equipments and determine whether n is smaller than or equal to J, to thereby verify the number of second user equipments applying for sharing. The server may provide a sharing application blacklist corresponding to the digital contents so that the first user equipment may check a sharing application for legality against the blacklist.

In exemplary embodiments, in order to ensure the security of interconnection between user equipments, second user equipments intended to share digital contents may first encrypt (encapsulate securely) their own equipment identifiers, respectively, by a public key of a first user equipment and then transmit the equipment identifiers to the first user equipment. Upon reception of the encrypted information transmitted from the second user equipments, the first user equipment may decrypt the encrypted information by its own private key to obtain the equipment identifiers of the respective second user equipments and then performs a subsequent process.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. A digital right management method, comprising:
generating, by a first user equipment which has access right to shared digital contents, a common public key based on one or more public keys of one or more second user equipments intended to share the digital contents, respectively;
encrypting, by the first user equipment, a key of the digital contents with the common public key to generate a ciphertext of the key of the digital contents;
generating, by the first user equipment, from the ciphertext a new authorization certificate corresponding to the digital contents; and
transmitting, by the first user equipment, the new authorization certificate and the digital contents to the second user equipments to instruct the second user equipments to share the digital contents in accordance with the new authorization certificate.

2. The method of claim 1, wherein generating the common public key comprises:
generating the common public key based on a public key of the first user equipment and the public keys of the second user equipments, respectively.

3. The method of claim 2, further comprising:
replacing, by the first user equipment, an original authorization certificate corresponding to the first user equipment with the new authorization certificate.

4. The method of claim 1, further comprising:
selecting, by the first user equipment, one or more of a plurality of user equipments currently connected with the first user equipment as the second user equipments.

5. The method of claim 1, further comprising:
obtaining, by the first user equipment, equipment identifiers and the public keys of the second user equipments intended to share the digital contents, respectively, from received requests for sharing the digital contents transmitted from the second user equipments.

6. The method of claim 1, wherein generating the new authorization certificate comprises:
determining a digest value based on the generated ciphertext and an original authorization certificate corresponding to the digital contents;
transmitting data including the digest value to a server and receiving from the server a signature value based on the digest value; and
generating the new authorization certificate based on the signature value, the ciphertext, and the original authorization certificate.

7. The method of claim 6, further comprising:
determining, by the server, that a sum of a number of first user equipments which have shared the digital contents and a number of the second user equipments is not larger than a maximum allowable number of sharing devices corresponding to the digital contents.

8. The method of claim 1, further comprising:
receiving, by one of the second user equipments, the new authorization certificate and the digital contents corresponding to the new authorization certificate transmitted from the first user equipment; and
decrypting, by the one of the second user equipments, the ciphertext of the key of the digital contents in the new authorization certificate with a private key of the one of the second user equipments, to obtain the key of the digital contents to access the digital contents corresponding to the new authorization certificate.

9. A first user equipment, comprising:
a common public key determining module configured to generate a common public key based on one or more public keys of one or more second user equipments intended to share digital contents, respectively;
a ciphertext generating module coupled to the common public key determining module and configured to encrypt a key of the digital contents with the common public key, to generate a ciphertext of the key of the digital contents;
an authorization certificate determining module coupled to the ciphertext generating module and configured to generate from the ciphertext a new authorization certificate corresponding to the digital contents; and
an authorization certificate transmitting module coupled to the authorization certificate determining module and configured to transmit the new authorization certificate and the digital contents to the second user equipments to instruct the second user equipments to share the digital contents in accordance with the new authorization certificate.

10. A digital right management method, comprising:
generating, by a server, a common public key from one or more public keys of one or more second user equipments intended to share digital contents, respectively;
encrypting, by the server, a key of the digital contents with the common public key to generate a ciphertext of the key of the digital contents;
generating, by the server, from the ciphertext a new authorization certificate corresponding to the digital contents; and
transmitting, by the server, the new authorization certificate to the second user equipments through a first user equipment which has access right to the digital contents to instruct the second user equipments to share the digital contents in accordance with the new authorization certificate.

11. The method of claim 10, wherein generating the common public key comprises:
generating the common public key from a public key of the first user equipment and the public keys of the second user equipments intended to share digital contents.

12. The method of claim 11, further comprising:
transmitting, by the server, the new authorization certificate to the first user equipment to instruct the first user equipment to replace an original authorization certificate corresponding to the first user equipment with the new authorization certificate.

13. The method of claim 10, wherein generating the new authorization certificate comprises:
determining a digest value based on the ciphertext and an original authorization certificate corresponding to the digital contents and signing the digest value to obtain a signature value; and
generating the new authorization certificate from the signature value, the ciphertext, and the original authorization certificate.

14. The method of claim 10, further comprising:
determining, by the server, that a sum of a number of user equipments which have shared the digital contents and a number of the second user equipments is not larger than a maximum allowable number of sharing devices corresponding to the digital contents.

15. A digital right management server, comprising:
a common public key generating module configured to generate a common public key from one or more public keys of one or more second user equipments intended to share digital contents, respectively;
an encrypting module coupled to the common public key generating module and configured to encrypt a key of the digital contents with the common public key to generate a ciphertext of the key of the digital contents;
an authorization certificate generating module coupled to the encrypting module and configured to generate from the ciphertext a new authorization certificate corresponding to the digital contents; and
a transmitting module coupled to the authorization certificate generating module and configured to transmit the new authorization certificate to the second user equipments through a first user equipment having access right to the digital contents, to instruct the second user equipments to share the digital contents in accordance with the new authorization certificate.
